(19) United States
(12) Patent Application Publication
(10) Pub. No.: US 2023/0159038 A1
(43) Pub. Date: May 25, 2023

(54) CONTROL DEVICE FOR CONTROLLING A VEHICLE FUNCTION FOR A VEHICLE, AND METHOD FOR OPERATING A CONTROL DEVICE

(71) Applicant: ZF Friedrichshafen AG, Friedrichshafen (DE)

(72) Inventors: Ilker BAGCI, Ravensburg (DE); Gowtham PERUMALSAMY, Markdorf (DE); Istvan HEGEDÜS-BITE, Eriskirch (DE); Timm MUNTEL, Friedrichshafen (DE); Mohammad ALSHARIF, Tettnang (DE); Hubert BICHELMEIER, Tettnang (DE); Bastian HUBRACHT, Salem (DE)

(73) Assignee: ZF Friedrichshafen AG, Friedrichshafen (DE)

(21) Appl. No.: 17/916,422

(22) PCT Filed: Mar. 10, 2021
(86) PCT No.: PCT/EP2021/056007

§ 371 Date: Sep. 30, 2022

(30) Foreign Application Priority Data
Mar. 30, 2020 (DE) 10 2020 204 076.1

(51) Int. Cl. B60W 50/00; B60R 16/03; G07C 5/08

(52) U.S. Cl. CPC B60W 50/00; B60R 16/03; G07C 5/0808

(57) ABSTRACT

A control device for controlling a vehicle function for a vehicle has at least one electronic or electrical component, at least one main switch, and one component switch. The component is designed to carry out the vehicle function. The main switch is connected via a power line between the component and a power supply connection for providing electricity to the component. The component switch is located between the component and the main switch and is designed to connect the component to the power line.

The present invention relates to a control device for a vehicle function for a vehicle and a method for operating the control device.

Current E/E architectures (electric/electronic architectures) in vehicles integrate only one or a few vehicle functions in each control device. This results in a very large number of control devices and software functions, with very complex networks.

This is the background forming the basis for the present invention with which an improved control device for vehicle functions in a vehicle, and a method for operating an improved control device is obtained according to the independent claims. Advantageous embodiments can be derived from the dependent claims and the following description.

The advantages with this approach are that a control device is created in which the individual components or modules for carrying out different vehicle functions can be switched on or off as needed. An embodiment of this forms a highly integrated control device, eliminating the need for individual control devices for each vehicle function.

A control device for controlling a vehicle function in a vehicle has at least one electronic or electrical component, at least one main switch, and one component switch. The component is designed to carry out the vehicle function. The main switch is on a power line between the component and a power supply with which the component is provided with electricity. The component switch is located between the component and the main switch and connects the component to the power line.

The vehicle can be a highly or fully automated vehicle for transporting people and/or goods. The component can be part of a module containing numerous electronic or electrical components for carrying out vehicle functions. The control device can also comprise this entire module. A power supply for the operating various components in the vehicle can be provided for the vehicle function. The main switch can be a switch with which all of the components connected to the control device can be supplied with electricity when it is activated, or all of the components connected to the control device can be separated from the power supply when it is deactivated. The component switch can be used to provide power to a specific component, or interrupt the power supply thereto. This makes it advantageously possible for the control device to provide or interrupt the power supply to any of the specific components. These components that are connected to the control device can all be placed on the same printed circuit board and/or located in the same housing.

The control device can also have at least one second electronic or electrical component for carrying out another vehicle function and a second component switch between the second component and the main switch with which the second component can be connected to the power line. The second vehicle function can differ from the first vehicle function. As a result, numerous vehicle functions can be controlled with a single control device. By way of example, when all of the switches are active, all of the components can be supplied with electricity, and when the main switch is switched off, none of the components are supplied with electricity, while when the main switch is on, and the first component switch is on, but the second component switch is off, only the first component is supplied with electricity, while when the main switch is on and the first component switch is off, but the second component switch is on, only the second component is supplied with electricity. This reduces power consumption, since only those components that are in use or needed for the various vehicle functions are supplied with electricity.

The first electronic or electrical component and second electronic or electrical component can be connected in parallel to the main switch.

It is also advantageous when the control device is connected to at least one third electronic or electrical component for carrying out another vehicle function, and there is a third component switch between the third component and the main switch that connects the third component to the power line. The third vehicle function can differ from the first and second vehicle functions. Consequently, numerous vehicle functions can be controlled with one control device. The control device can also be connected to an arbitrary number of other electronic or electrical components that each carry out different vehicle functions in the vehicle and each have dedicated component switches between these respective components and the main switch that each connect the respective components to the power line.

According to one embodiment, the control device can also have a second main switch connected by a second power line between the component and a second power supply connection to a second power supply, and/or a second component switch between the component and the second main switch for connecting the component to the second power line. This results in a redundant system that can be activated if the first main switch, the first power line, and/or the first component switch malfunction(s).

The first power line and second power line can be galvanically separated from one another and/or electrically insulated from one another. This means that the component can be supplied with electricity via either the first power line or the second power line. The first power line can be designed in this case to be connected to the first power supply and the second power line can be connected to the second power supply, and the first and second power supplies can differ from one another. By way of example, the first power supply connection can be to a 12 volt power source, and the second power supply connection can be to another power source that provides electricity at 48 volts. The power sources can also provide the same number of volts such that they function in a redundant manner.

It is also advantageous if the control device according to one embodiment contains a supply voltage transformer connected to the component via another power line between the main switch and an additional component switch, wherein the supply voltage transformer is designed to transform the voltage of the power supply. This transformer can be designed to reduce and/or boost the power supply voltage. As a result, the first component can be supplied with one voltage from a power supply, and the second component can be supplied by the same power supply with another voltage. The control device can also contain the voltage transformer, which is connected to the second main switch and the second component switch for the first component via the second power line or a third power line.

The control device can also have a monitoring device that is designed to detect an error in the component and/or switch the component switch on and/or off if an error has been detected in the component. This error can be a defect or malfunction in the control device. With such a monitoring device, a defective component can advantageously be shut off, or the malfunctioning component can be reset.

The control device can also have a second monitoring device that is designed to detect an error in the control device and/or switch the main switch on and/or off if an error has been detected in the control device. The error can be a defect or malfunction in the control device. With such a monitoring device, the complete control device can be reset if it malfunctions, for example.

The second monitoring device can also be designed to detect an error in the power supply connection and shut off the main switch if this is the case. It is also conceivable that the second monitoring device is designed to detect an error in the power supply connection and shut off the second main switch if the error has been detected in the power supply connection.

According to another embodiment, the second monitoring device can also be designed to detect an error in the power supply connection and shut off the main switch if an error has been detected in the power supply connection, and when the second main switch is then simultaneously switched on, the power supply remains intact via the power supply connection without interruption. Analogously, the second monitoring device can also be designed to detect an error in the power supply connection and switch off the second main switch if an error is detected in the power supply connection, and then switch the first main switch on at the same time, such that the power supply remains intact via the power supply connection without interruption.

In another embodiment, the monitoring device can be designed to keep both main switches on or to switch them on, and if an error occurs at the power supply connection, the main switch is then switched off. If an error is detected at the second power supply connection, the second main switch can be shut off by the first or second monitoring unit. This results in greater availability as the result of an uninterrupted power supply.

Furthermore, another embodiment of the invention presented herein may be particularly advantageous in a situation in which both main switches are on because a corresponding amount of power is necessary. If an error is then detected at the power supply connection, the main switch is shut off, for example, and the modules are shut off via the component switches, i.e. the switches for them are switched off, in accordance with a priority list, to prevent an overload to a second power line serving as the supply line.

According to one embodiment, the control device can have at least one power supply storage unit, in particular a supercapacitor, and/or a buffer battery, designed to provide an additional power supply. Such a power supply storage unit may be useful in the case of a vehicle blackout in that it can continue to provide electricity for the vehicle. The main switch(es) can be switched off if a vehicle blackout occurs.

The component can form a communication interface, computer unit, voltage transformer, processor, electronic sensor, actuator and/or power distributer. These form the typical components used for carrying out vehicle functions.

A method for operating a control device in the form of one of the variations described above has a providing step and an activating step. The control device is provided in the providing step. The power supply connection is subjected to the power supply in the activating step, such that the control device is placed in operation.

This method can be implemented in a control device, for example, by software or hardware, or a mixture thereof.

A computer program is also advantageous, which contains program code that can be stored on a machine-readable medium such as a semiconductor memory, hard disk, or an optical disc, and is used to carry out the method according to any of the embodiments described above when the program is executed on a computer or a device.

Exemplary embodiments of the approach presented herein are illustrated in the drawings and explained in greater detail in the following description. Therein:

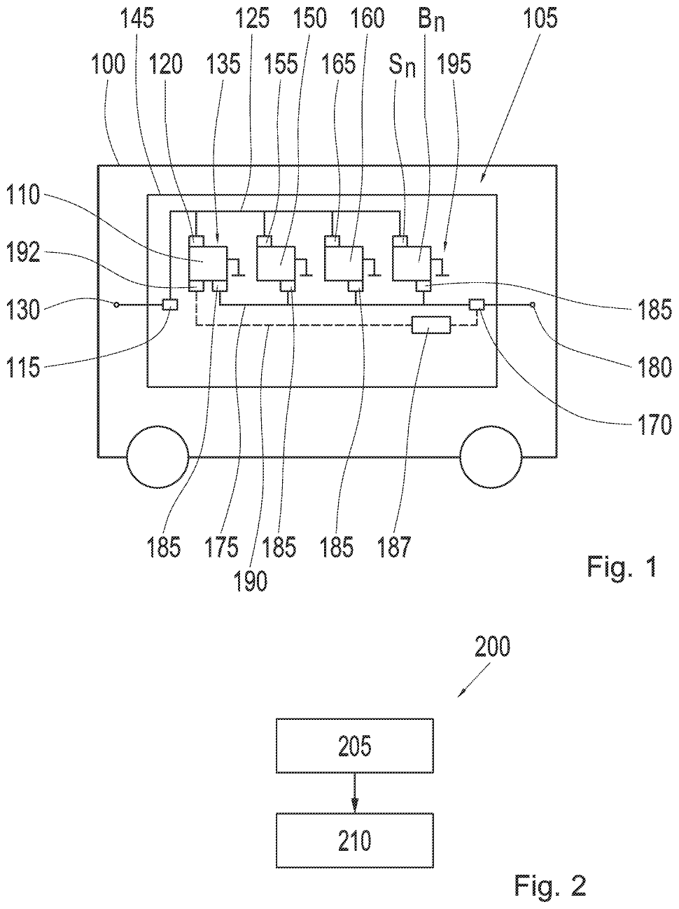

FIG. 1 shows a schematic illustration of a vehicle that has a control unit for a vehicle function according to an exemplary embodiment; and

FIG. 2 shows a flow chart for a method for operating a control device according to an exemplary embodiment.

The same or similar reference symbols are used in the following description of preferred exemplary embodiments of the present invention for the elements shown in the various figures having similar functions, whereas the descriptions of these elements shall not be repeated.

FIG. 1 shows a schematic illustration of a vehicle 100 that has a control device 105 for controlling a vehicle function in the vehicle 100 according to an exemplary embodiment.

The control device 105 has at least one electronic or electrical component 110, at least one main switch 115, and one component switch 120. The component 110 is designed to carry out the vehicle function. The main switch 115 is connected by a power line 125 between the component 110 and a power supply connection 130 through which power is supplied to the component 110. The component switch 120 is located between the component 110 and the main switch 115 and is designed to connect the component 110 to the power line 125.

Merely by way of example, the control device 105 according to this exemplary embodiment is accommodated on or in the vehicle 100. The vehicle 100 is designed as a highly or fully automated vehicle 100 in this exemplary embodiment, intended for transporting people and/or goods. The vehicle function comprises a driving function for the highly or fully automated operation, or an arbitrary vehicle component in the vehicle 100, for example. The component 110 is part of a module 135 comprising numerous electronic or electrical components 110 in this exemplary embodiment, and the module 135 is designed to carry out the vehicle function. The control device 105 according such an exemplary embodiment comprises this entire module 135. These components 110, 115, 125 and/or 130 in the control device 105 are located in this exemplary embodiment on the same printed circuit board 145 and/or in the same housing.

The control device 105 in this exemplary embodiment also contains at least one second electronic or electrical component 150 for carrying out a second vehicle function in the vehicle 100, and a second component switch 155 located between the second component 150 and the main switch 115, with which the second component 150 is connected to the power line 125.

The second vehicle function differs from the first vehicle function in this exemplary embodiment. The first electronic or electrical component 110 and the second electronic or electrical component 110 are connected in parallel to the main switch in this exemplary embodiment. Furthermore, the control device 105 in this exemplary embodiment has at least one third electronic or electrical component 160 for carrying out a third vehicle function, and a third component switch 165 located between the third component and the main switch, which connects the third component 160 to the power line 125. The third vehicle function differs from the first vehicle function and the second vehicle function in this exemplary embodiment. The control device 105 also has an arbitrary number of additional electronic or electrical components Bn according to one exemplary embodiment, each of which carries out a different vehicle function in the vehicle 100 and has a respective dedicated component switch Sn, each of which are located between the additional component Bn and the main switch 115, for connecting the additional components Bn to the power line 125. The second component 150, third component 160, and/or the additional components Bn can also each be part of an individual module composed of numerous second components 150, third components 160, and/or additional components Bn. The modules can differ from one another.

According to this exemplary embodiment, the control device 105 also has a second main switch 170, which is connected by a second power line 175 to the component 110 and a second power supply connection 180 for a second power supply, and/or a second component switch 185 between the component 110 and the second main switch 170, which connects the component 110 to the second power line 175.

The first power line 125 and the second power line 175 are galvanically separated from one another in this exemplary embodiment. The first power line 125 provides the first power supply in this exemplary embodiment, and the second power line 175 provides the second power supply, wherein the first power supply and second power supply can have either the same or different voltages. By way of example, the first power supply connection 130 is connected to a power source in this exemplary embodiment that provides electricity at 12 volts, and/or the second power supply connection 180 is connected to another power supply that provides electricity at 48 volts. The second component 150, third component 160, and/or additional components Bn also each have a second component switch 185 in this exemplary embodiment, which connects the second component, third component 160 and/or additional components Bn to the second power line 175.

The control unit 105 also has a supply voltage transformer 187 in this embodiment, which is connected by another power line 190 between the second main switch 170 or the first main switch 115 and an additional component switch 192 for the component 110, wherein the supply voltage transformer 187 is designed to transform the second power supply or the first power supply. According to one exemplary embodiment, the supply voltage transformer 187 is designed to reduce and/or boost the second power supply voltage or the first power supply voltage, respectively. The control device 105 can also contain one or more of these supply voltage transformers 187 according to one exemplary embodiment, which is/are connected via one or more additional power lines between the first main switch 115 or second main switch 170 and the respective dedicated component switches for the second component 150, third component 160, and/or additional components Bn.

The control device 105 also has a monitoring device in one exemplary embodiment, which is designed to detect an error in the component 110 and/or switch the first component switch 120 and/or the second component switch 185 of the component 110 and/or the additional component switch 192 of the component 110 on and/or off if an error is detected in the component 110. The monitoring device in this exemplary embodiment is also designed to detect an error in the second component 150, third component 160, and/or additional components Bn, and/or switch the respective dedicated, or all respective dedicated component switches 155, 165, 185, Sn for the second component 150, third component 160, and/or additional components Bn on and/or off, if an error is detected in the second component 150, third component 160, and/or additional components Bn. The control device 105 in this exemplary embodiment also has another monitoring device designed to detect an error in the control device 105 and/or switch the first main switch 115 and/or second main switch 170 on and/or off if an error is detected in the control device 105. According one exemplary embodiment, the control device 105 has at least one power supply storage unit, e.g. a supercapacitor and/or buffer battery, designed to provide an additional power supply for the component 110, or all of the components 110, 150, 160, Bn.

The first component 110, second component 150, third component 160, and/or additional components Bn in this exemplary embodiment form a communication interface, computer unit, voltage transformer, processor, electronic sensor, actuator, and/or power distributer. The first component 110, second component 150, third component 160, and/or additional components Bn are each connected in this exemplary embodiment to a ground connection 195.

In the highly integrated control device 105 presented herein, it is advantageously possible to provide a power supply in which diverse vehicle functions can be integrated. Despite the numerous functions in the vehicle 100, advantageously only one control device 105 is needed in the vehicle 100 for the large variety of functions. Most of the control devices that are used cannot be upgraded and are designed to carry out the same functions over the entire course of the vehicle's lifetime. Software updates can be carried out to a limited extent “over the air,” or in garages. There are normally no hardware updates. The devices that are used are state of the art at the time that the vehicle is created, and normally have few reserves for reducing costs. It is also necessary with autonomous vehicles to ensure, on the basis of the SAE levels (classification levels for automation levels), that the vehicle will continue to function in the event of an error, e.g. in the power supply (i.e. remain fail-operational). The control device 105 presented herein enables all of this.

The components 110, 150, 160, Bn in the form of hardware components or functions are integrated in the control device 105 presented herein and adapted with regard to their size and shape for the application in question, and combined in the manner of building blocks. With this modular printed circuit board construction, numerous different models can be advantageously integrated in a central platform. The layout for the printed circuit boards is optimized by combining specific functions and groups thereof in appropriate regions. This also reduces interferences caused by thermal discharge, short circuits, or overheating.

The first main switch 115 on the first power supply connection 130 for the first power supply and/or the second main switch 170 on the second power supply connection for the second power supply are/is used to switch the entire path to all components 110, 150, 160 Bn or their modules on and off in the case of an error, e.g. due to a short circuit, overload, overheating, and/or malfunction. These errors are either detected at the switches through measurements of the current or voltage, or by the monitoring device in the respective module. The monitoring in one embodiment can also take place via a separate upstream or downstream module. Optionally, the supply voltage, or another, second, external supply voltage can be used to continue supplying power to the modules when there is problem in the power supply. If there is a problem in the power supply, the switch is switched off in one exemplary embodiment via the main switch 115, e.g. via a semiconductor element, to prevent feedback. If an error occurs in a module containing components 110 such as a standardized processor for external sensor signals, actuator control, power distributer and/or power supply, the first power supply and/or second power supply are switched on or off according to one exemplary embodiment via the component switch Sn, 120, 155, 165, 185, 192. As a result, the malfunctioning modules are isolated from all of the other modules, and a hard reset is carried out according to one exemplary embodiment. A reliable state is obtained according to one exemplary embodiment by switching the power supply off. Energy is saved according to one exemplary embodiment by targeted switching off consumers that are not necessary. Furthermore, the first supply voltage and second supply voltage can be the same, e.g. 12 volt or 48 volt, or they can be different, e.g. 12 V and 48 V, or 12 V and high voltage serving as the main power supply. High voltage is regarded as voltages between 60 V and 1.5 kV in DC voltage. Different voltages can also be used for the actuators with different nominal voltages, i.e. in the third power line 190. If the second power supply is 48 V and the first power supply is 12 V, as is the case in one exemplary embodiment, then the 48 V can be transformed to 12 V using the supply voltage transformer 187 in the form of a DC/DC transformer. By providing an uninterrupted power supply, availability is significantly increased in the control device 105, which can also be referred to as the “ECU.” Optionally, supercapacitors or buffer batteries can temporarily ensure continued functioning in the case of a vehicle blackout. In this case, the main switch(es) 115, 170 are switched off.

The main features of the control device 105 presented herein are summarized as: the power supply with the main switch 115 and individual component switches 120, 155, 165, Sn in the form of switches on modules (without redundancy). Optionally, there can also be the second power supply with the second main switch 170 and the second and/or third component switches 185, 192 in the form of individual switches on components (with redundancy). Optionally, there are different voltage levels for the power supply and the second power supply, with the possibility of an internal variation in the voltage.

Furthermore, the second monitoring device can be designed to detect an error in the control device 105 and/or switch the second main switch 170 on and/or off, if an error has been detected in the control device 105. The second monitoring device is also designed in one exemplary embodiment to detect an error in the power supply connection 130 and to switch the main switch 115 off if an error has been detected at the power supply connection 130. In another exemplary embodiment, the second monitoring device is also designed to detect an error at the power supply connection 180 and to switch the second main switch 170 off if an error has been detected at the power supply connection 180. According to another exemplary embodiment, the second monitoring device is also designed to detect an error at the power supply connection 130 and to switch the main switch 115 off if an error has been detected at the power supply connection 130. In this case, by switching the second main switch 170 on at the same time, the power supply can continue to be provided without interruption via the second power supply connection 180.

It is also conceivable that the second monitoring device is designed to detect an error at the power supply connection 180, and to switch the second main switch 170 off if an error has been detected at this power supply connection 180, while the power supply can continue to be provided without interruption via the first power supply connection 130 by switching the first main switch 115 on at the same time.

In another exemplary embodiment, the first monitoring device or the second monitoring device is designed to keep both main switches switched on or to switch them on, and if an error occurs at the power supply connection 130, the main switch 115 is then switched off. If an error is detected at the second power supply connection 180, the second main switch 170 can be switched off by the first monitoring unit or the second monitoring unit. This results in higher availability through the implementation of an uninterrupted power supply. Furthermore, another exemplary embodiment of the approach presented herein is beneficial, specifically for a situation in which both main switches 115 and 170 are switched on, because a lot of power is needed, for example. If an error is then detected at the power supply connection 130, the main switch 115 is then switched off, for example, and the modules are shut off via the second component switches 185, i.e. these switches 185 are switched off, in accordance with a priority list, so that a second power line serving as the power line 175 is not overloaded.

For another situation, an exemplary embodiment of the approach presented herein is also advantageous in which the two main switches 115 and 170 are switched on, because a lot of power is needed. If an error is detected at the second power supply connection 180, the second main switch 170 is then switched off, and the modules are shut off via the component switches 120, 155, 165 Sn, i.e. these component switches 120, 155, 165 Sn are switched off, so that a power line 125 serving as the power line is not overloaded.

FIG. 2 shows a flow chart for a method 200 for operating a control device according to an exemplary embodiment. This can be the control device described in reference to FIG. 1.

The method 200 has a providing step 205 and an activating step 210. In the providing step 205, the control device is provided. In the activating step 210, the power supply connection is subjected to the power supply to operate the control device.

The exemplary embodiments described herein and shown in the drawings are selected merely by way of example. Different exemplary embodiments can be combined with one another in their entirety or with regard to individual features. One exemplary embodiment can also be supplemented by features from another exemplary embodiment.

Furthermore, the steps of the method presented herein can be repeated, as well as carried out in a sequence other than that described herein.

If an exemplary embodiment comprises an “and/or” conjunction between a first feature and a second feature, this is to be read to mean that the exemplary embodiment according to one embodiment contains both the first feature and the second feature, and in another embodiment, contains either just the first feature or just the second feature.

### LIST OF REFERENCE SYMBOLS

Bn further components
Sn dedicated component switches
100 vehicle
105 control device
110 component
115 main switch
120 component switch
125 power line
130 power supply connection
135 module
145 printed circuit board
150 second component
155 second component switch
160 third component
165 third component switch
170 second main switch
175 second power line
180 second power supply connection
185 further component switch
187 supply voltage transformer
190 third power line
192 additional component switch
195 ground connection
200 method for operating a control device
205 providing step
210 activating step

1. A control device for controlling vehicle functions for a vehicle, wherein the control device comprises:
at least one electronic or electrical component configured to carry out vehicle functions;
at least one first main switch connected by a first power line between the component and a first power supply connection configured to provide a first power supply to the component;
a component switch between the component and the first main switch that connects the component to the first power line; and
a second main switch that is connected by a second power line between a second power supply connection configured to provide a second power supply different from the first power supply and at least one of the component and/or a further component switch located between the component and the second main switch that is configured to connect the component to the second power line,
wherein the first power line and the second power line are galvanically separated from one another and/or electrically isolated from one another.

2. The control device according to claim 1, further comprising:
at least one second electronic or electrical component configured to carry out a second vehicle function in the vehicle; and
a second component switch located between the second component and the first main switch, the second component switch configured to connect the second component to the first power line.

3. The control device according to claim 2, wherein the first electronic or electrical component and the second electronic or electrical component are connected in parallel to the first main switch.

4. The control device according to claim 2, further comprising:
at least a third electronic or electrical component configured to carry out a third and/or redundant vehicle function in the vehicle; and
a third component switch located between the third component and the first main switch, the third component switch configured to connect the third component to the first power line.

5. (canceled)

6. (canceled)

7. The control device according to claim 1, further comprising:
a supply voltage transformer that is connected via a third power line between the first main switch or the second main switch, and an additional component switch for the component, wherein the supply voltage transformer is designed to transform the first supply voltage or the second supply voltage.

8. The control device according to claim 1, further comprising:
a monitoring device configured to detect an error in the component and/or switch the component switch on and/or off in response to an error being detected in the component.

9. The control device according to claim 1, further comprising:
a second monitoring device configured to detect an error in the control device and/or switch the first main switch on and/or off in response to an error being detected in the control device.

10. The control device according to claim 1, further comprising:
a second monitoring device configured to perform at least one of the following:
detect an error in the control device and/or switch the second main switch on and/or off in response to an error being detected in the control device;
detect an error at the first power supply connection and to switch the first main switch off in response to an error being detected at the first power supply connection;
detect an error at the second power supply connection and to switch the second main switch off in response to an error being detected at the second power supply connection;
detect an error at the first power supply connection and to switch the first main switch off in response to an error being detected at the first power supply connection; and/or
detect an error at the second power supply connection and to switch the second main switch off in response to an error being detected at the second power supply connection.

11. The control device according to claim 1, further comprising:
at least one power supply storage unit configured to provide an additional power supply for the component.

12. The control device according to claim 1, wherein the component comprises a communication interface, computer unit, voltage transformer unit, battery, processor, electronic sensor, actuator, and/or power distributer.

13. A method for operating a control device comprising:
providing at least one electronic or electrical component configured to carry out at least one vehicle function by of a vehicle;
providing a first power supply connection of the control device;
providing a second power supply connection of the control device;
providing at least one first main switch connected by a first power line between the component and the first power supply connection;
providing at least one second main switch connected by a second power line between the second power supply connection and the component and/or a further component switch located between the component and the second main switch that is configured to connect the component to the second power line;
galvanically separating or electrically isolating the first power line and the second power line from one another;
providing a first power supply to the at least one component via the at least one first main switch;
providing a second power supply to the at least one component via the at least one second main switch;
providing at least one component switch between the component and the first main switch that connects the component to the power line;
activating the first power supply at the first power supply connection to operate the control device; and
activating the second power supply at the second power supply connection to operate the control device.

14. (canceled)

15. The control device according to claim 3, further comprising:
at least a third electronic or electrical component configured to carry out a third and/or redundant vehicle function in the vehicle; and
a third component switch located between the third component and the main switch, the third component switch configured to connect the third component to the power line.

16. The control device according to claim 2, further comprising:
a supply voltage transformer that is connected via a third power line between the first main switch and an additional component switch for the component, wherein the supply voltage transformer is designed to transform the supply voltage.

17. The control device according to claim 4, further comprising:
a supply voltage transformer that is connected via a third power line between the first main switch and an additional component switch for the component, wherein the supply voltage transformer is designed to transform the supply voltage.

18. The control device according to claim 2, further comprising:
a monitoring device configured to detect an error in the component and/or switch the component switch on and/or off in response to an error being detected in the component.

19. The control device according to claim 4, further comprising:
a monitoring device configured to detect an error in the component and/or switch the component switch on and/or off in response to an error being detected in the component.

20. The control device according to claim 7, further comprising:
a monitoring device configured to detect an error in the component and/or switch the component switch on and/or off in response to an error being detected in the component.

21. The control device according to claim 2, further comprising:
a second monitoring device configured to detect an error in the control device and/or switch the first main switch on and/or off in response to an error being detected in the control device.

22. The control device according to claim 4, further comprising:
a second monitoring device configured to detect an error in the control device and/or switch the first main switch on and/or off in response to an error being detected in the control device.

23. The control device according to claim 8, further comprising:
a second monitoring device configured to detect an error in the control device and/or switch the first main switch on and/or off in response to an error being detected in the control device.
